(19) United States
(12) Patent Application Publication
(10) Pub. No.: US 2017/0087875 A1
(43) Pub. Date: Mar. 30, 2017

(54) Methods of Printing an Image on a Coated Substrate

(71) Applicant: Sauder Woodworking Co., Archbold, OH (US)

(72) Inventors: Phillip A. Bontrager, Archbold, OH (US); John Robert Beck, Archbold, OH (US)

(21) Appl. No.: 15/278,191

(22) Filed: Sep. 28, 2016

Related U.S. Application Data
(60) Provisional application No. 62/234,390, filed on Sep. 29, 2015.

(51) Int. Cl. B41J 11/00; D21H 19/82

(52) U.S. Cl. CPC B41J 11/002; D21H 19/828

(57) ABSTRACT

A method of printing an image on a substrate is described. Particularly, a coated covering adhered to a substrate may undergo plasma treatment to facilitate printing an image on the coated covering. Plasma treatment may be used to raise the surface energy of the coated covering to allow for printing an image on the coated covering.

### CROSS REFERENCE TO RELATED APPLICATION

This application claims priority to U.S. Ser. No. 62/234,390, filed Sep. 29, 2015. The entire contents of the aforementioned application are incorporated herein.

### FIELD

The present disclosure relates to methods of printing an image on a substrate.

### INTRODUCTION

It is an objective of the furniture industry to provide decorated component parts where the decoration is registered in a specific position on the finished part. Conventional wide web printing of decoratives lacks the ability to decorate in-register due to mass manufacturing methods because large panel saws are used that prioritize waste efficiency over registration of the decorative pattern on the cut pieces. Wide web printed decoratives also require long development lead times and large volume requirements to be cost-effective. These 4 to 5 foot wide rolls of decorative micropaper in excess of 10,000 feet long (50,000 sq. ft.) are mass produced at high speeds as well, such that it is infeasible to print a particular image on the micropaper roll in a particular position so that it might line up well in a future furniture cutting on the large panel saws. To require such a thing would be to dedicate an entire paper roll SKU (stock keeping unit) to a particular individual furniture component, an infeasible proposal in a competitive industry.

Other methods such as thermally fusing products using melamine have been used. In such processes a decorative is first printed on a micropaper prior to pressing onto a substrate. Such processes are slow and require large amounts of time and resources to produce the finished part.

“Low Pressure” thermally fused laminate (TFL) products are manufactured by impregnating an alpha cellulose decorative paper with melamine resin. This impregnated paper is then pressed on to a sheet of composite panel substrate to produce the fully decorated panel. The pressure used to press the laminate assembly is in the 300-400 psi range with temperatures in excess of 300° F. “High Pressure” thermally fused laminate (HPL) products are manufactured by impregnating layers of kraft paper with phenolic resin and combining with an alpha cellulose melamine impregnated decorative paper. Higher press pressures are used in producing high pressure laminates (HPL) (in excess of 1,000 psi) compared to Low Pressure TFL. The final HPL product is a thin sheet that must later be laminated to the composite panel using an adhesive layer (typically by a downstream customer) in order to produce the fully decorated panel. High pressure HPL generally costs more to produce than Low Pressure TFL, but is considered to have superior physical properties.

### DRAWINGS

The drawings described herein are for illustrative purposes only of selected embodiments and not all possible implementations, and are not intended to limit the scope of the present disclosure.

FIG. 1 shows a side view of a substrate with a covering and a coating.

FIG. 2 shows a substrate with a covering and a coating undergoing plasma treatment.

FIG. 3 shows an exploded view of a substrate with a covering and a printed image on a coating.

### SUMMARY

In one embodiment, the invention described herein includes a method of making a printed substrate, comprising:

a) providing a substrate having a substrate surface;

b) affixing a coated covering on the substrate surface;

c) exposing the coated covering to a plasma; and

d) printing an image on the coated covering to form the printed substrate.

In some embodiments, the substrate comprises wood. In other embodiments, the substrate comprises a wood composite. In some embodiments, the substrate may comprise other materials, such as plastic, metal, or fiberglass. In some embodiments, the substrate surface is substantially flat.

A covering that may be coated to form a coated covering is a micropaper laminate. In other embodiments, a covering that may be coated to form a coated covering is a material designed to have a wood-like appearance.

Some embodiments include exposing the coated covering to a plasma by a plasma treater. In some embodiments, a plasma treater is an apparatus for exposing an object to a plasma such as a flame, corona plasma, atmospheric-pressure plasma, or chemical plasma. The conveyor may be a belt, rollers, or any other style.

The plasma treater may be a flame treater. The flame treater may include an air flow apparatus having an air flow rate, and the air flow rate may be between about 18.8 and about 25 liters/minute per inch of burner length. In some embodiments, the air flow rate is about 21.3 liters/minute per inch of burner length.

In some embodiments, the plasma is a flame. The flame may be generated by a fuel, the fuel may have a flow rate, and the flow rate may be between about 2.0 and about 2.6 liters/minute per inch of burner length when using natural gas as a fuel, and about 0.8 and about 1.1 liters/minute per inch of burner length when using propane as a fuel. In other embodiments, the fuel flow rate is between about 2.2 and about 2.4 liters/minute per inch of burner length when using natural gas a fuel. In other embodiments, the fuel flow rate is between about 0.9 and about 1.0 liters/minute per inch of burner length when using propane as a fuel. In some embodiments the fuel may be provided at a fuel supply pressure, and the fuel supply pressure may be between about 0.5 and about 3 pounds per square inch gauge (psig).

In one embodiment, the coated covering is moved at a speed of between about 25 and about 70 feet/minute relative to the plasma. In other embodiments, the coated covering is moved at a speed of between about 33 and about 60 feet/minute relative to the plasma. In some embodiments, the plasma treater includes a conveyor belt, and the coated covering may be moved by the conveyor belt while being exposed to the plasma.

The coated covering may be exposed to the plasma a plurality of times (more than one time) before printing the image. In some embodiments, there is a delay between each exposure of the coated covering to the plasma. In some embodiments the delay is less than about 20 seconds. In other embodiments, the delay is less than about 10 seconds.

In some embodiments, there is a gap between the plasma and the coated covering. The gap between the plasma and the coated covering during exposure may be between about 0.5 and about 2 inches. In some embodiments, the gap between the plasma and the coated covering is about 1.5 inches.

In some embodiments, the plasma is a flame and the fuel used by the flame is selected from the group consisting of propane and natural gas.

In some embodiments, the image is printed in ink. The ink may be a curable ink. In some embodiments, the ink is cured after printing. The ink may be cured using UV light. In some embodiments, the image is printed with an ink jet printer. In some embodiments, the ink jet printer is a water-based ink jet printer. In other embodiments, the printer is a screen printer.

The coating may contain silicon.

Exposing the coated covering to the plasma may raise the surface energy of the coated covering. In some embodiments, exposing the coated covering to the plasma raises the surface energy to greater than about 70 dynes/cm.

In some embodiments, the printing is conducted within about one month of exposing the coated covering to the plasma. In other embodiments, the printing is conducted while the surface energy of the coated covering is greater than about 70 dynes/cm.

In other embodiments, the invention includes a product made by the method described herein.

In another embodiment, a method of making a printed substrate includes:

a) providing a substrate having a substrate surface;

b) affixing a covering on the substrate surface;

c) coating the covering with a coating to form a coated covering;

d) exposing the coated covering to a plasma; and

e) printing an image on the coated covering to form the printed substrate.

In some embodiments, the substrate comprises wood. In other embodiments, the substrate comprises a wood composite. In other embodiments, the substrate may comprise a material selected from the group consisting of plastic, metal, and fiberglass. In some embodiments, the coated covering may be a coated micropaper. The coating may be a highly siliconized durable topcoat, or the plasma may be a flame or a corona.

### DESCRIPTION

As used in this description, “a,” “an,” “the,” “at least one,” and “one or more” indicate interchangeably that at least one of the item is present; a plurality of such items may be present unless the context unequivocally indicates otherwise.

All numerical values of parameters (e.g., of quantities or conditions) in this specification, including the appended claims, are to be understood as being modified in all instances by the term “about” whether or not “about” actually appears before the numerical value.

“About” indicates that the stated numerical value allows some slight imprecision (with some approach to exactness in the value; approximately or reasonably close to the value; nearly). If the imprecision provided by “about” is not otherwise understood in the technological field with this ordinary meaning, then “about” as used herein indicates at least variations that may arise from ordinary methods of measuring and using such parameters. In addition, disclosure of ranges are to be understood as specifically disclosing all values and further divided ranges within the range.

The terms “comprising,” “including,” and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed.

As used in this specification, the term “or” includes any one and all combinations of the associated listed items.

A method of printing an image on a coated covering is described. The method includes providing a substrate 110 (such as a component of furniture) having a substrate surface, affixing a covering 120 to the surface of the substrate 110, coating the covering to form a coated covering 120/130, exposing the coated covering to a plasma 212, and printing an image 310 on the coated covering 120/130. Any image 310 may be printed on the coated surface 120/130 including a decorative pattern or design registered in position on the part as desired. After completing the inventive process, the coated covering 120/130 bears a decorative image.

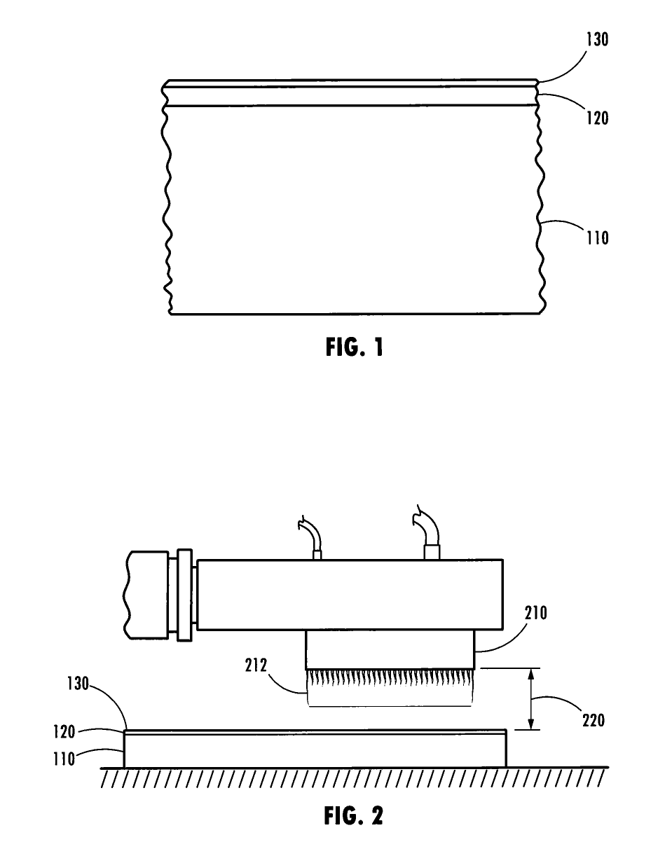

FIG. 1 shows a substrate 110 with a covering 120 and a coating 130. In some embodiments, the covering 120 is affixed to the substrate 110. The coating 130 may then be applied on the covering 120.

The substrate 110 may be a block or a whole, partial or cut sheet of wood. In other embodiments, the substrate 110 may be a wood composite such as particle board or fiber board. In further embodiments, the substrate 110 may comprise other materials, such as plastic, metal or fiberglass. The substrate 110 may be suitable for use as a piece of furniture, or component thereof, such as a component of ready-to-assemble furniture. After completing the inventive process, the printed substrate may be suitable as a door, drawer front, upright, chest, crate, credenza, desk or any other item, for example, a flat surface component of furniture. The substrate 110 may have a decorative edging material such as plastic or paper backed edgebanding, or a hot stamp transfer foil.

The substrate 110 has a substrate surface which, in one embodiment, is substantially flat. A covering 120 is laminated on the substrate surface. The covering 120 may be a micropaper. “Micropaper” as used herein may be used to describe a printed paper weighing between 25 and 150 grams per square meter. The base composition of the micropaper may be cellulose derived from wood, or any other cellulose containing component. The micropaper may comprise a blank piece of paper coated with ink to provide a basic color tone. The micropaper may contain multiple passes with additional ink that varies in color to provide a desired decorative pattern. De-wetting agents may also be applied to the micropaper to give the appearance of wood grain “ticking” or etching. In some embodiments, the covering 120 is coated with a coating 130 for sheen and durability. The coating 130 also may contain acrylated urethane, acrylated polyester, catalyzed varnish, melamine coating, or nitrocellulose lacquer. In other embodiments, the coating 130 may be a water-based or solvent-based formulation. In some embodiments, the coating 130 is cured. Curing of the coating 130 may be accomplished by thermal or radiation curing.

Micropapers may have a coarser or a smoother finish. Coarser micropaper provides greater topographic variation that can provide more mechanical anchors for ink adhesion.

The covering 120 may vary in appearance, including various wood-like finishes or a painted appearance such as a single color. The covering 120 may vary according to the coarseness of the surface to provide different ink adhesion properties. In some embodiments, the desired plasma treatment may vary based on the coarseness of the covering. Micropaper manufactured by Toppan®, Dai Nippon®, or Bausch Linneman® may be used in the inventive process.

The covering 120 also may be a polymeric material such as polypropylene.

In some embodiments, the covering 120 is coated with a coating 130 before being affixed to the substrate. In other embodiments, the covering 120 is affixed to the substrate and then coated with the coating 130.

The uncoated covering 120 or coated covering 120/130 may be affixed or laminated to the substrate 110 with an adhesive system. In some embodiments, the adhesive system is a catalyzed urea formaldehyde adhesive system applied using heat and pressure. The covering 120 or coated covering 120/130 may be applied with a paper application apparatus. In some embodiments, the paper application apparatus involves conveying the substrate 110 through the paper application apparatus at speeds ranging from 20 meters/minute up to 65 meters/minute. In some embodiments, the substrate 110 is wood or wood composite, and the substrate 110 is sanded prior to application of the covering to improve substrate smoothness. In some embodiments, the substrate 110 is contacted with a hot oil heated rotating steel roller, then the urea formaldehyde adhesive is directly applied to the substrate 110 with a rotating soft roller. The urea formaldehyde may be heated with infrared radiation to drive off moisture. A catalyst may then be applied to the urea formaldehyde by a soft roller. Then, the covering 120 or coated covering 120/130 may be pressed onto the moving substrate 110 by a rotating hot oil heated embossing steel roller.

Other affixing or lamination processes for pressing a covering or decorative micropaper are generally known in the art. For instance, an electron beam cured thermoset adhesive may be used. In another embodiment, a hot melt acrylated polyester adhesive may be used to affix the covering 120 or coated covering 120/130 to the substrate 110. In another embodiment, a polyolefin hot melt thermoplastic adhesive may be used. In another embodiment, a polyvinyl acetate adhesive may be used. In yet another embodiment, a polyurethane adhesive may be used. Any suitable lamination process may be used in the method described herein. In some embodiments, the lamination process uses thermoset adhesives to affix the covering 120 or coated covering 120/130 to the substrate 110.

In one embodiment, the coating 130 is applied to the covering 120 after the covering 120 has been applied to or affixed to the substrate 110. In some embodiments, the coating 130 is pre-applied to the covering 120 (before the covering 120 has been affixed to the substrate 110). In some embodiments, the coated covering may be purchased with a pre-applied acrylated urethane, acrylated polyester, catalyzed varnish, melamine coating, or nitrocellulose lacquer. The coating 130 may in some embodiments be a water-based or solvent-based formulation that is cured. In some embodiments the coating 130 is cured using convection heating. In other embodiments, the coating 130 is cured using radiation.

The coating 130 may provide a glossy appearance to the covering 120. The weight of the coating 130 may vary based on desired durability or other physical properties. Coating weight may be measured as a thickness of the coating 130. Generally, a lower weight coating 130 provides superior ink adhesion. In some embodiments, the coated covering 120/130 may have a weight between about 25 and about 150 grams per square meter. The coating 130 may also vary in gloss level. Generally, a lower gloss level provides superior ink adhesion properties during the printing process. In some embodiments, the gloss level of the coating may be below 70 units according to ASTM D-523-99 at 60°. The coating 130 may also contain silicon. Any suitable coating 130 may be used in the method described herein.

Upon plasma treatment, the coating 130 may be oxidized by the plasma. Suitable coatings may include ester, ether, carbonyl, hydroxyl groups or combinations thereof. These functional groups may be oxidized by the plasma treatment to provide groups with greater reactivity to free radical containing species. Silicon-containing coatings may be oxidized to form silicon dioxide groups in the coating.

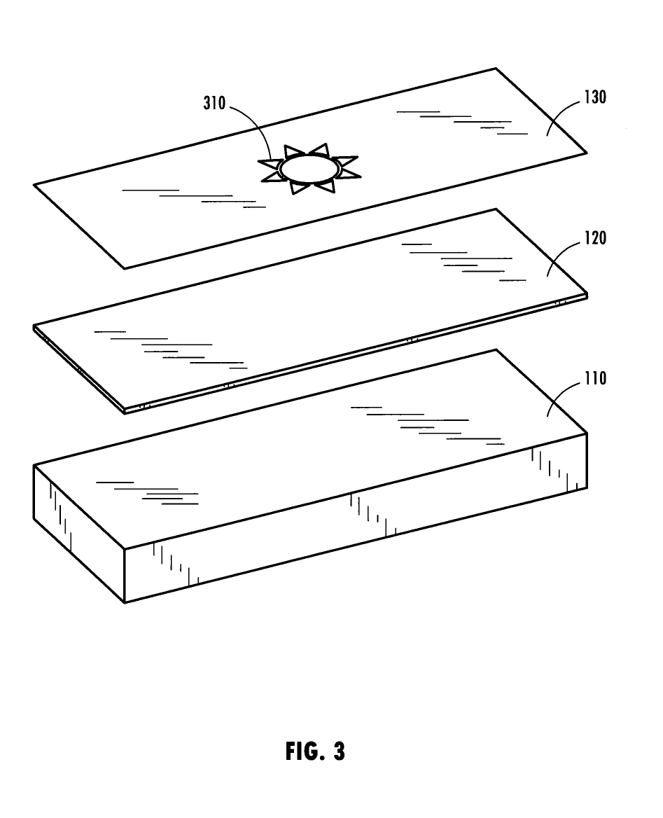

FIG. 2 shows a substrate 110 with covering 120 and coating 130 undergoing plasma-treatment by a burner 210 producing a plasma 212.

The substrate 110 having the laminated and coated covering 120/130 is plasma-treated. This plasma-treatment is intended to provide increased ink adhesion to the coated covering 120/130 as compared with a non-plasma treated panel. Plasma-treaters as described herein may comprise a conveyor, and one or more burners producing a plasma. One such example of a plasma-treater suitable for use in the described method is the Enercon® Dyn-A-Flame Plasma Treatment Model EC-CF0040-111.

Plasma treatments suitable for use in the method may include flame plasma treatment, corona plasma treatment, atmospheric-pressure plasma treatment, or chemical plasma treatment.

Flame plasma treatment includes combining a flammable gas such as propane or natural gas and air to produce a flame. Flame treatment may polarize and oxidize the surface of the coated covering 120/130 and raise the surface energy.

Corona plasma treatment uses a high voltage electrode, or grouping of electrodes to create a plasma curtain. The effect of corona treatment is similar to flame treatment. However, corona treatment is a lower temperature process and thus may be used on temperature sensitive substrates. Atmospheric-pressure plasma treatment includes multiple types of plasma that are at a pressure substantially the same as atmospheric pressure. Chemical plasma treatment includes a process that ionizes a gas other than air to produce a plasma.

The length of the burner 210 may vary. In some embodiments, the length of the burner 210 is between about 8 and about 24 inches. In other embodiments, the length of the burner 210 is between about 12 and about 20 inches. In further embodiments, the length of the burner 210 is about 16 inches.

Several parameters in the plasma treating step may be varied to provide different adherence of the ink to the coated covering 120/130. For example, substrate 110 having the coated covering 120/130 may be moved relative to the plasma 212 during the plasma exposure step. In some embodiments, the substrate 110 having the coated covering 120/130 may be moved relative to the plasma 212 at a speed between about 25 and about 70 feet/minute. In other embodiments, the substrate 110 having the coated covering 120/130 may be moved relative to the plasma 212 at a speed between about 33 and about 60 feet/minute. In some embodiments, the substrate 110 having the coated covering 120/130 may be moved by a conveyor. The conveyor speed of the plasma treater may vary. A slower conveyor speed results in a longer exposure time of the panel to the plasma. Slower conveyor speeds and thus longer exposure to the plasma treatment step may be necessary depending on the covering 120 and coating 130 used.

As shown in FIG. 2, the substrate 110 with coated covering 120/130 is exposed to the plasma 212 with a gap 220 therebetween. The gap 220 between the coated covering 120/130 and the plasma 212 may be varied. In some embodiments, the gap 220 may be between about 0.5 and about 2 inches. In other embodiments, the gap 220 may be about 1.5 inches. The gap 220 between the plasma 212 and the coated covering 120/130 may vary based on the specific covering 120 and the coating 130 used. A shorter gap 220 may be necessary for a greater surface energy activation and thus greater ink adhesion.

In some embodiments, the plasma 212 is a flame. Fuel is flowed or fed to and generates the flame. The fuel is flowed at a specified rate; however, the fuel flow rate may also vary. The fuel flow rate may vary depending on the fuel used. The fuel may be propane, natural gas, or any other appropriate fuel. In some embodiments, the fuel flow rate may be between about 2.0 and about 2.6 liters/minute per inch of burner length when the fuel is natural gas, and about 0.8 and about 1.1 liters/minute per inch of burner length when the fuel is propane. In other embodiments, the fuel flow rate may be between about 2.2 and about 2.4 liters/minute per inch of burner length when the fuel is natural gas, and 0.9 and 1.0 liters/minute per inch of burner length when the fuel is propane. Fuel flow rate may be adjusted to provide different ink adhesion properties to the coated covering 120/130. The fuel may be provided at a pressure between about 0.5 and about 3 psig.

For embodiments in which the plasma 212 comprises a flame, air is flowed or fed to and generates the flame. The air is flowed at a specified rate; however, the air flow rate may vary. The air flow oxygenates the burner and maintains the plasma 212. The air flow may be adjusted based on the covering 120 and coating 130 used, as well as the amount of ink necessary to print the image 310. In some embodiments, the air flow rate is between about 18.8 and about 25 liters/minute per inch of burner length. In other embodiments, the air flow rate is about 21.3 liters/minute per inch of burner length.

In some embodiments, the substrate 110 having the affixed and coated covering 120/130 is exposed to the plasma 212 a plurality of times. The additional exposure to the plasma 212 may be necessary to fully activate the surface energy of the coated covering 120/130 to successfully adhere the printed ink to it. In some embodiments, the coated covering 120/130 is exposed to the plasma up to five times. In some embodiments, multiple burners 210 may be placed along a conveyor for exposing the substrate 110 with the coated covering 120/130 to the plasma 212 multiple times while the substrate 110 travels along the conveyor. The time between separate exposures to the plasma 212 also may vary. The time between exposures to the plasma 212 may be referred to as a “delay”. In some embodiments, the delay may be up to about 20 seconds. In other embodiments, the delay is up to about 10 seconds.

Without being bound to any particular theory, it is believed that the plasma treatment step increases the surface energy of the coated surface to improve ink adhesion in the printing step. A typical laminated substrate with a coating may have a surface energy in the range of about 20 to about 40 dynes/cm. However, according to the present invention, following plasma treatment, the coated covering 120/130 may have a surface energy of greater than about 70 dynes/cm as measured by ASTM D 2578. Testing the coated covering 120/130 for increased surface energy according to ASTM D 2578 includes applying fluids with surface tension values up to 70 dynes/cm. The surface energy of the coating is above 70 dynes/cm if the fluid does not break into droplets in less than 2 seconds after applying the fluid to the surface.

The increased surface energy of the coated covering 120/130 allows for improved wetting and adhesion of other substances, such as ink, to the coated covering 120/130. Increased surface energy due to plasma treatment may last up to several days or even weeks, thus allowing for adequate time to complete the printing step.

Plasma treatments may vary depending on the type of coating 130 or covering 120 used. More aggressive plasma treatments may be necessary for coverings with smoother finishes or coatings with greater coating weight. In some embodiments, the plasma treatment may vary based on the type of ink or image printed on the coated covering 120/130. More aggressive plasma treatments may include higher fuel flow rates, higher air flow rates, a slower speed of the substrate 110 relative to the plasma 212, a smaller gap 220, or more exposures to the plasma.

FIG. 3 shows an exploded view of the substrate 110, the covering 120, and the coating 130. The coating 130 includes an image 310 printed thereon. The image 310 may be any desired image. In some embodiments, the image 310 is printed in ink and is decorative.

In one embodiment of the invention, following plasma treatment, an image 310 is printed on the coated covering 120/130. The image 310 may be printed using a variety of methods. In some embodiments, the image 310 is printed using an ink jet printer or any other suitable printer type. Following the printing step, the ink may have greater adhesion to the surface than a non-plasma-treated surface, resulting in greater resistance to wiping with water, cleaners, and furniture polishes. Depending on the ink and printing process used, different levels of surface activation may be necessary to achieve adequate ink adhesion to the coated covering. A suitable printer for use in the described method includes the Fujifilm Acuity Advance Select 6 digital ink jet printer.

Possible inks for use in the present invention may include cyan, magenta, yellow, black, and white. In some embodiments the inks have the colors light cyan, light magenta, light black, and light black. Specialty colors may also be used in other embodiments. In some embodiments, the cyan, magenta, yellow, and black ink may comprise 30-50% isobornyl acrylate ester, 30-50% 2-phenoxyethyl acrylate, 15-30% N-vinylcaprolactam, and 1-5% phenyl bis (2,4,6-trimethylbenzoyl)-phosphine oxide. In some embodiments, the white ink may comprise 15-30% isobornyl acrylate ester, 15-30% 2-phenoxyethyl acrylate, 15-30% N-vinylcaprolactam, and 5-10% 2,4,6-trimethylbenzoyl diphenyl phosphine oxide.

A curable ink may be used to print the desired image on the coated covering. In some embodiments, a water-based ink may be used with digital ink jet printing or screen printing. The ink may be cured using any known method in the art. In some embodiments, the ink is cured using ultraviolet (UV) light. The digital print speed, print quality, and UV cure required during printing is variable and depends on the image being printed. Higher quality images may require more ink and slower printing speeds.

Digital print speed and print quality are settings on printers that determine how fast the image is printed and at what visual quality. In some embodiments the print carriage speed remains constant at the various speed and quality settings, but the width of the printed image may change with each pass of the printer. In such an embodiment, the fastest print speed has the widest print area swath while the slowest print speed has the narrowest print area swath.

In some embodiments, the printer may be run in “bidirectional” mode or in “unidirectional” mode. In bidirectional mode the print carriage prints in both directions as it sweeps over the part, while in unidirectional mode the print carriage prints in one direction only. As a result, bidirectional mode prints faster than unidirectional.

Particular speed and quality modes may dispense different amounts of ink while printing. The higher the quality mode the more ink may be used on a given image. In one embodiment, the speed and quality mode for a given image is selected by testing various modes and selecting the mode that provides satisfactory visual quality at the highest possible speed.

In some embodiments, at higher speeds, the wider swaths printed may reveal noticeable banding in the image that slower speeds do not have. Higher quality modes generally produce images with better depth and color quality compared to lower quality modes. The end use of the printed image plays a role in selecting the required print quality. An image viewed from a longer distance may take advantage of a lower print quality and higher print speed, and an image viewed from a shorter distance may use a higher print quality and lower print speed. Printer speeds may be described in beds per hour, with the total printed area output speed of the printer calculated as the product of the speed in beds per hour and the bed size of the printer used. In some embodiments, when a printer with a 4 ft.×8 ft. bed is being used, print speeds may vary from about 3 to about 25 beds per hour.

In some embodiments, the printer is an ink jet printer, and the gap between the printer ink head and the coated covering 120/130 may be changed according to the type of coated covering 120/130 used. In some embodiments the gap between the printer ink head and the coated covering 120/130 is about 0.040 inches to about 0.45 inches. In some embodiments, the gap between the printer ink heads is about 0.060 inches.

### Examples

To print an image on a substrate, plasma treatment was performed on three commercially available cellulose micropaper laminate coated coverings. The commercial names refer to specific commercially available coated coverings. “Soft White” refers to paper manufactured by BAUSCHLINNEMANN, Greensboro, N.C. “Cobblestone” refers to paper manufactured by TOPPAN, Morgantown, Pa. “Scribed Oak—Textured version” refers to paper manufactured by TOPPAN, Tokyo, Japan. The printing step may be successfully performed from anywhere within 1 minute to 30 days after plasma treatment. The following parameters for plasma treatment and printing were used to print an image on the coated covering adhered to a substrate.

TABLE 1
Plasma treatment and printing parameters for Examples 1-3.

| | | | Cellulose | | |
|---|---|---|---|---|---|
| | | | Micropaper | | |
| | | | Laminate | | |
| | | Substrate | Coated | Micropaper | |
| | | Wood | Covering | Laminate Coated | |
| | | Composite | Commercial | Covering Weight | |
| Example | Description | Core | Name | (grams per square meter) | |
| 1 | Rolling Chest | Particle Board | “Soft White” | 60 | |
| 2 | Desk | Particle Board | “Cobblestone” | 45 | |
| 3 | 4 Drawer | Particle Board | “Scribed Oak- | 50 | |
| | Chest | | Textured | | |
| | | | Version” | | |
| | Micropaper | | | | |
| | Laminate | Micropaper | Micropaper | Micropaper | |
| | Coated Covering | Laminate | Laminate Coated | Laminate | |
| | Topcoat | Coated Covering | Covering Topcoat | Coated Covering | |
| Example | Chemistry | Ink Chemistry | Gloss* Range | to Core Adhesive | |
| 1 | Radiation Cured | Water Based | 20-30 | Catalyzed Urea | |
| | (Electron Beam) | | | Formaledhyde | |
| | Acrylated Urethane | | | | |
| 2 | Thermally Cured | Solvent Based | 15-21 | Catalyzed Urea | |
| | Acrylated Urethane | | | Formaledhyde | |
| 3 | Thermally Cured | Solvent Based | =<10 | Catalyzed Urea | |
| | Acrylated Urethane | | | Formaledhyde | |
| | | | | | Gap from |
| | | | | Plasma Treater | Plasma |
| | | | Plasma Treater | Air Flow Rate | Treater Base |
| | Plasma | Plasma Treater | Fuel Flow Rate | (liters per | to Covering |
| | Treater** | Fuel Supply | (liters per minute | minute per | Surface |
| Example | Fuel | Pressure (psig) | per inch of burner) | inch of burner) | (inches) |
| 1 | Propane | 0.5 | .90 | 21.3 | 1.5 |
| 2 | Propane | 0.5 | .90 | 21.3 | 1.5 |
| 3 | Propane | 0.5 | .90 | 21.3 | 1.5 |
| | | | Distance Between | | |
| | Plasma Treater | Number | Plasma Treaters | Printer*** | |
| | Conveyor Speed | of Plasma | for Multiple | Ink Colors | Printer Ink |
| Example | (feet per minute) | Treatment Passes | Passes (feet) | Used | Cure Method |
| 1 | 51 | 3 | 8 | Cyan, Magenta, | Ultraviolet |
| | | | | Yellow, Black | (UV) Light |
| 2 | 38 | 3 | 8 | Cyan, Magenta, | Ultraviolet |
| | | | | Yellow, Black | (UV) Light |
| 3 | 33 | 2 | 8 | White | Ultraviolet |
| | | | | | (UV) Light |

| | | Gap Between Printer | |
|---|---|---|---|
| | Printer UV | Ink Heads & Printed | Printer Speed |
| Example | Cure Setting | Coated Covering (inches) | (Beds per Hour) |
| 1 | 7 | 0.060 | 12 |
| 2 | 9 | 0.060 | 10.5 |
| 3 | 9 | 0.060 | 4.9 |

*Gardner Micro Gloss-@ 60° (MD)-ASTM D-523-99
**“Plasma Treater” is an Enercon Dyne-A-Flame ™ Surface Treater, Model EC-CF0040-111
***“Printer” is a Fujifilm ™ Acuity Advance Select 6 Channel UV Flatbed Printer with a 4 foot × 8 foot Bed

The foregoing description of particular embodiments illustrate features of the invention, but the invention is not limited to any of the specific embodiments that have been described. The features described for particular embodiments are interchangeable and can be used together, even if not specifically shown or described. The same may also be varied in many ways. The invention broadly includes such variations and modifications.

1. A method of making a printed substrate, comprising:
a) providing a substrate having a substrate surface;
b) affixing a coated covering on the substrate surface;
c) exposing the coated covering to a plasma; and
d) printing an image on the coated covering to form the printed substrate.

2. The method of claim 1, wherein the substrate comprises a material selected from the group consisting of wood, a wood composite, plastic, metal, and fiberglass.

3. The method of claim 2, wherein the substrate comprises wood.

4. The method of claim 1, wherein the coated covering is a micropaper having a coated surface.

5. The method of claim 1, wherein the coated covering is moved at a speed of between about 25 and about 70 feet/minute relative to the plasma.

6. The method of claim 5, wherein the plasma treater includes a conveyor, which moves the coated covering relative to the plasma.

7. The method of claim 1, wherein the plasma is selected from the group consisting of a flame, a corona, atmospheric plasma, or chemical plasma.

8. The method of claim 7, wherein the plasma is a flame.

9. The method of claim 8, wherein the flame is generated by a fuel and the fuel flows at a flow rate.

10. The method of claim 9, wherein the fuel used by the flame is selected from the group consisting of propane and natural gas.

11. The method of claim 10, wherein the fuel is propane and the fuel flow rate is between about 0.80 and about 1.1 liters/minute per inch of burner length.

12. The method of claim 10, wherein the fuel is natural gas and the fuel flow rate is between about 2.0 and about 2.6 liters/minute per inch of burner length.

13. The method of claim 9, wherein the fuel is supplied at a fuel supply pressure, and the fuel supply pressure is between about 0.5 and about 3 psig.

14. The method of claim 6, wherein the plasma treater includes an air flow apparatus having an air flow rate, and the air flow rate is between about 18.8 and about 25 liters/minute per inch of burner length.

15. The method of claim 1, wherein the coated covering is exposed to the plasma a plurality of times before the image is printed.

16. The method of claim 15, wherein there is a delay between each exposure of the coated covering to the plasma, and the delay is less than about 20 seconds.

17. The method of claim 1, wherein there is a gap between the plasma and the coated covering during exposure, and the gap is between about 0.5 and about 2 inches.

18. The method of claim 1, wherein the image is printed in ink.

19. The method of claim 18, wherein the ink is curable and the ink is cured after printing.

20. The method of claim 19, wherein the ink is cured using UV light.

21. The method of claim 1, wherein the image is printed with an ink jet printer or a screen printer.

22. The method of claim 1, wherein the coated covering includes a coating and the coating contains silicon.

23. The method of claim 1, wherein the coated covering has a surface energy after exposure to the plasma, the surface energy is greater than about 70 dynes/cm, and the printing step is conducted while the surface energy is greater than about 70 dynes/cm.

24. A product made according to the method of claim 1.

25. A method of making a printed substrate, comprising:
a) providing a substrate having a substrate surface;
b) affixing a covering on the substrate surface;
c) coating the covering with a coating to form a coated covering;
d) exposing the coated covering to a plasma; and
e) printing an image on the coated covering to form the printed substrate.

26. The method of claim 25, wherein the substrate comprises a material selected from wood, wood composite, plastic, metal, and fiberglass.

27. The method of claim 25, wherein the coated covering is a coated micropaper.

28. The method of claim 25, wherein the coating is a highly siliconized durable topcoat.

29. The method of claim 25, wherein the plasma is a flame or corona plasma.
